(19) United States
(12) Patent Application Publication
(10) Pub. No.: US 2016/0038864 A1
(43) Pub. Date: Feb. 11, 2016

(54) Composite High Efficiency Filter Media With Improved Capacity

(71) Applicant: Clarcor Engine Mobile Solutions, LLC, Franklin, TN (US)

(72) Inventors: Farrell Francis Calcaterra, Kearney, NE (US); Tom Green, Liberty Township, OH (US); Lei Li, West Chester, OH (US); Tetyana Gilbert, Manchester, CT (US); Vardhan Bajpai, Ellington, CT (US); Zhiwang Wu, Spring Hill, TN (US); Chad Andrew Taylor, Kearney, NE (US)

(21) Appl. No.: 14/819,617

(22) Filed: Aug. 6, 2015

Related U.S. Application Data
(60) Provisional application No. 62/033,839, filed on Aug. 6, 2014.
(60) Provisional application No. 62/187,982, filed on Jul. 2, 2015.

(51) Int. Cl. B01D 39/16; B01D 39/20

(52) U.S. Cl. CPC B01D 39/1623; B01D 39/1615; B01D 39/2017

(57) ABSTRACT

A composite filter media includes a base sheet incorporating polymer microfibers and nano-fibrillated cellulose in combination with one or more alternative upstream depth filtration layers. Embodiments of the composite filter media employ polymer or fiberglass layers arranged on the upstream face of the base sheet. A lightweight protective spun bond scrim may be applied to the upstream face of the upstream depth filtration material. The depth filtration layer or layers may be laminated to each other and/or the base sheet or co-pleated with the base sheet to form the disclosed composite media. The depth filtration layers are configured to provide a positive density gradient in the direction of fuel flow through the composite media, meaning that the depth filtration media increases in density and decreases in pore size in the direction of fuel flow.

### FIELD OF INVENTION

The embodiments disclosed herein relate generally to high efficiency and high capacity filtration media and to filters and methods of filtering liquids such as diesel fuel which employ said media.

### BACKGROUND

Filtration media possessing high filtration efficiency of fine particulates generally requires pores in the media smaller than the particle diameter. The media has a “sieve” effect preventing the fine particulates from passing through the media. However, small pores in a media generally result in low permeability and therefore cause high fluid pressure drop across the media. The effectiveness of a filter media at removing particulates of a specified size is said to be its “efficiency.” When particulates are captured physically on the upstream side of the media, they will over time gradually block the pores of the media, which in turn will cause the fluid pressure drop across the media to gradually increase beyond the design parameters for the system. Filter media is also rated by the length of time before a pre-determined pressure drop across the media is reached. This measure of media performance is called the “capacity” of the filter media. If the specific predetermined pressure is reached too rapidly, the resulting media capacity will thus be low. The general rule is that the higher the efficiency possessed by a filtration media, the lower its capacity.

Several factors are having an impact on diesel fuel filter design. Fuel emissions standards are becoming more stringent, driving changes to fuel injection systems toward tight tolerance precision parts and higher injection pressures. Pumps designed to generate high injection pressures and precision injection system components can be damaged by water, very small hard particles or clogged by accumulations of soft particles, so engine manufacturers have been calling for fuel filtration systems that provide very clean, dry fuel. Practical service intervals require that consumable filter components have significant longevity, which requires the replaceable filter element to separate water, capture and hold a variety of hard and soft particles from a large volume of fuel.

A modern diesel engine uses (combusts) only some of the fuel it pulls from the tank. A significant portion of the fuel taken from the tank is circulated through the high pressure fuel pump and to the injectors operating under enormous pressure and high temperatures. The excess fuel is used to cool and lubricate the precision parts of the high pressure pump and injectors and what is not used (injected into the cylinders) goes back to the tank at temperatures between 140° F. and 200° F. This return fuel is very hot and may promote polymerization and fuel breakdown. Eventually, more and more solids from the tank will reach the filter and over time, can plug the filter. These problems continuously occur in commercially operated engines, such as trucks, heavy equipment, shipping, and power generation, but will also appear in recreational boats, RV's and all types of fuel storage tanks. Asphaltenes in fuel delivered to the combustion chamber can have a dramatic negative effect on combustion efficiency and emissions.

Asphaltenes are highly polarized long chain components in crude and heavier refined oils. Under certain circumstances these compounds associate themselves to form complex colloidal structures. In Low Sulfur Diesel (LSD—S-500), High Sulfur Diesel (HSD—S-5000) and heating and bunker fuels the higher aromatic content of the fuel tends to discourage the formation of the complex colloidal structures limiting the problem. However the EPA mandated reduction in aromatic content in ULSD has allowed this problem to happen sooner, more often, and in cooler temperatures than had been seen previously. The exact molecular structures of asphaltenes are difficult to determine. As they are currently understood, asphaltenes are composed mainly of polyaromatic carbon ring units with oxygen, nitrogen, and sulfur heteroatoms, combined with trace amounts of heavy metals, particularly chelated vanadium and nickel, and aliphatic side chains of various lengths. Many asphaltenes from crude oils around the world contain similar ring units, which are linked together to make highly diverse large molecules. Asphaltenes have a tendency to agglomerate into an oily sludge. This problem is made worse when water is present.

Current diesel fuel differs significantly from diesel of 15-20 years ago. In the past, refineries used only about 50% of a barrel of crude oil to make distillates such as gasoline, jet fuel and diesel fuel. The remainder of the barrel of crude oil went to “residual oil” such as lubricating oils and heavy oils. Today, as a result of different refining techniques and additive packages, the refinery uses 85% or more of the same barrel of crude, which clearly has consequences for fuel stability. In addition, requirements within the U.S. since 2007 of Ultra Low Sulfur Diesel (ULSD) fuels further impacts fuel performance in on-road diesel engine equipment. 2014 will see the requirement that all diesels, on-road and off-road, required to use ULSD. Further, some regions of the U.S. also use a percentage of bio-diesel blended into fuels. All of these changes can result in fuel with poor thermal stability and a tendency to form solids when exposed to pumps and the hot surfaces and pressure of the fuel injection system. This can result in an increase in asphaltene agglomerations, polymerization and a dramatic loss of combustion efficiency. Under the circumstances present in a modern fuel injected diesel engine, a majority of the particulates in the fuel are soft particles such as asphaltenes. Some estimate that as much as 90% of particulates present in the fuel tank are soft particles.

Conventional commercially available filtration media often contain a base-media that provides what was an acceptable filtration efficiency, e.g. from 100% wood pulp, and a laminated layer of fine staple fibers that provides the required filtration capacity. However, standards for filtration efficiency have been raised, making the previously acceptable filtration media no longer sufficient.

Filter media design has emphasized the pore structure of the media, with a uniform, fine pore structure necessary to trap and retain very small particles. Given the direct relationship between pore size and the diameter of fibers making up the filter media, achieving a uniform/consistent pore structure with openings small enough to remove particles in the 2-4 micron size range at efficiencies of greater than 90% requires fibers having an average diameter of less than 1 μm, or so called “nanofibers.” Prior art materials based primarily on natural fibers such as cellulose cannot typically achieve such fine particle removal efficiencies with an acceptable pressure drop across the media.

It would be desirable to improve the efficiency of a filter media, particularly with respect to small particles, while maintaining the required filtration, pressure drop, capacity or other attributes such as burst strength, overall thickness and stiffness. Such filtration media should also possess a minimum strength sufficient to be further processed and/or pleated (e.g., so as to allow for the formation of filter units comprising such media).

### SUMMARY

A composite filter media is disclosed, comprising a base sheet incorporating polymer microfibers and nano-fibrillated cellulose in combination with one or more alternative upstream depth filtration layers. Embodiments of the composite filter media employ meltblown polymer or fiberglass layers arranged on the upstream face of the base sheet. A lightweight protective spun bond scrim may be applied to the upstream face of the upstream depth filtration material. The depth filtration layer or layers may be laminated to each other and/or the base sheet or co-pleated with the base sheet to form the disclosed composite media. The depth filtration layers are configured to provide a positive density gradient in the direction of fuel flow through the composite media, meaning that the depth filtration media increases in density and decreases in pore size in the direction of fuel flow.

The base sheet provides high efficiency in the removal of fine particulates as small as 4 μm, with significant efficiency with respect to particles as small as 2 μm. The base sheet is formed primarily of synthetic microfiber, which results in consistent pore structure and high strength. These enhanced properties permit use of a relatively thin and lightweight base media having a low pressure drop, even while achieving high fine particle efficiencies. The base media has an efficiency of between 78-80% for removal of 2 μm particles.

The upstream depth filtration material enhances the particulate holding capacity and life of the composite media by trapping larger particles, while providing alternate channels for the fuel to flow through. The selected depth filtration materials achieve the desired positive density gradient and reduction in pore size by having larger diameter fibers at or near an upstream face and progressively smaller diameter fibers in the direction of fuel flow. The depth filtration materials may be unitary “phased” material constructed from fibers having diameters that decrease from an upstream face to a downstream face of the media. Alternative depth filtration materials can be assembled from discrete layers of uniform fiber diameter, with each layer selected and arranged to provide the desired density/porosity gradient.

The disclosed depth filtration materials have an average diameter that is greatest at an upstream face and which is reduced by at least approximately 80% at the downstream face of the depth media. Since the pore size and density in a non-woven web are directly related to the diameter of the constituent fibers, the disclosed upstream depth media has a positive density gradient, being more open (less dense) at the upstream face and more dense with smaller pore sizes at the downstream face. This configuration traps larger particles at the upstream face of the composite media, while allowing fuel and smaller particles to flow into the depth of the media where smaller particles are trapped in smaller pores. The base media at the downstream face of the depth media provides high efficiency with respect to removal of fine particles in the 2-4 μm diameter range. The disclosed composite media is particularly effective in cyclic flow tests that are reflective of real world use of filter appliances utilizing the composite media. The composite media has significantly enhanced contaminant holding capacity. The depth media and/or the assembled composite media may be treated to enhance the hydrophobicity, which improves water separation from fuel as it passes through the media.

### BRIEF DESCRIPTION OF THE DRAWINGS

FIG. 1 is an enlarged partial sectional view through the disclosed composite media;

FIG. 2 is a 1000× enlargement of the upstream surface of a phased fiberglass media layer according to aspects of the disclosure;

FIG. 3 is a 1000× enlargement of the downstream face of a first phase of a phased fiberglass media according to aspects of the disclosure;

FIG. 4 is a 1000× enlargement of the upstream face of a second phase of a phased fiberglass media according to aspects of the disclosure;

FIG. 5 is a 1000× enlargement of the downstream face of a second phase of a phased fiberglass media according to aspects of the disclosure;

FIG. 6 is a graphical presentation of fiber size distribution derived from the image of FIG. 2;

FIG. 7 is a graphical presentation of fiber size distribution derived from the image of FIG. 3;

FIG. 8 is a graphical presentation of fiber size distribution derived from the image of FIG. 4;

FIG. 9 is a graphical presentation of fiber size distribution derived from the image of FIG. 5;

FIG. 10 is a graphical presentation of 4 μm particle removal efficiency for a benchmark OE compared to two configurations of composite media according to aspects of the disclosure;

FIG. 11 is a graphical presentation of filter life and 4 μm particle removal efficiency for untreated and hydrophobic treated composite media according to aspects of the disclosure;

FIG. 12 is a graphical presentation of 4 μm particle removal for a benchmark filter media compared to the disclosed composite media under cyclic flow test conditions;

FIG. 13 is a graphical presentation of 5 μm particle removal for a benchmark filter media compared to the disclosed composite media under cyclic flow test conditions;

FIG. 14 is a graphical presentation of 6 μm particle removal for a benchmark filter media compared to the disclosed composite media under cyclic flow test conditions;

FIG. 15 is a sectional view through a filter element constructed with the disclosed composite media;

FIGS. 16-18 graphically present the fiber diameter distribution for a three layer synthetic non-woven depth media according to aspects of the disclosure; and

FIG. 19 is a graphical presentation of 4 μm particle removal for an embodiment of the disclosed composite media constructed from the base medium and a synthetic non-woven depth medium.

### DETAILED DESCRIPTION

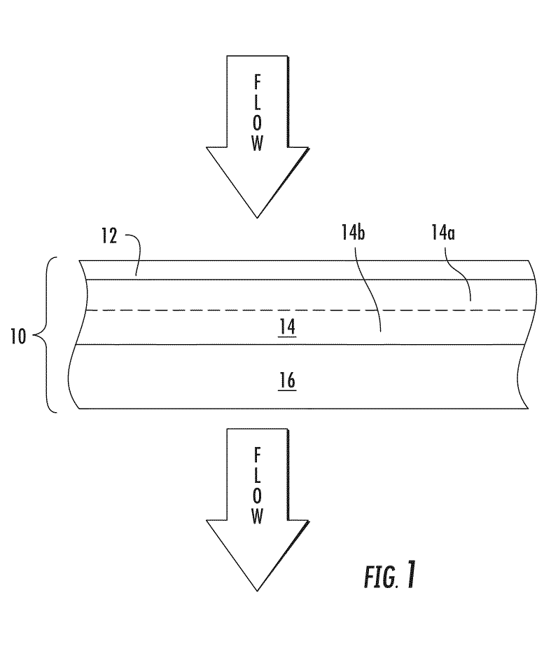

FIG. 1 is a sectional view of the disclosed composite media 10, showing (from upstream face to downstream face) an optional lightweight protective scrim 12, a depth media 14, and a base media 16. The composite media 10 is intended to filter diesel fuel for delivery to fuel injection systems of internal combustion diesel engines for on road and off road vehicles as well as power generation and marine applications, but is not limited to only this use. Fuel flows through the composite media from an upstream face at the optional protective scrim to a downstream face at the outlet side of the base media 16. The depth media 14 and base media 16 will be discussed in terms of “upstream” and “downstream” faces, which relate to the direction of fuel flow through the composite media 10.

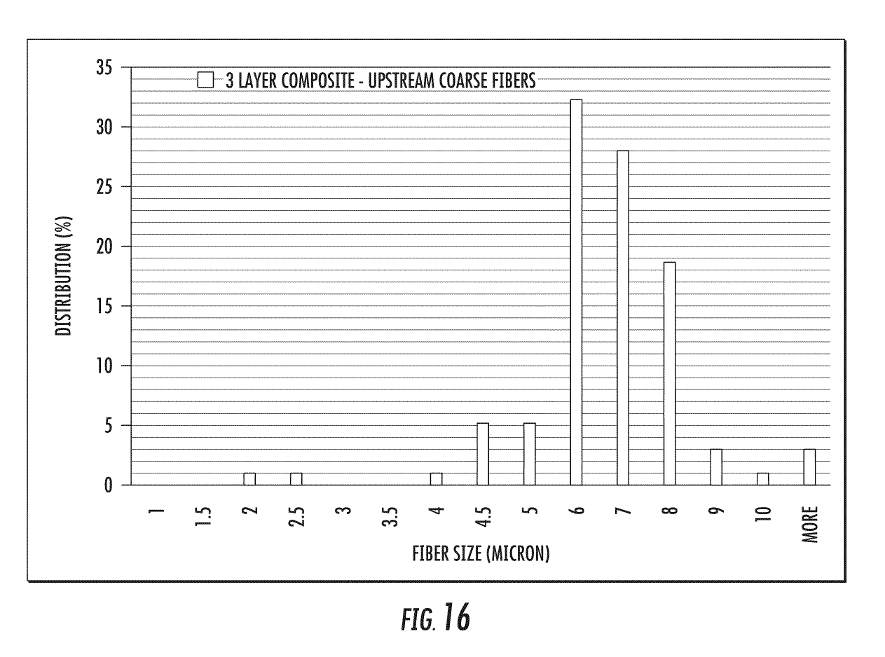

The disclosed composite media may be used to manufacture filter elements or filter cartridges for use in conjunction with fuel delivery systems. An exemplary filter element 30 is illustrated in FIG. 15. The filter element 30 includes an upper end cap 32 spanning an upper end of a pleated closed cylinder of composite filter media 10, and a lower end cap 34 spanning the lower end of the pleated cylinder of composite filter media 10. The upper end cap 32 defines an opening for filtered fuel to exit the filter element 30. Flow is directed through the composite media 10 from an inlet (upstream) face at the outside diameter of the cylinder of composite media 10 to an outlet (downstream) face at the inside diameter of the cylinder of composite media 10. The upper and lower end caps 32, 34 are sealed and bonded to the upper and lower ends of the pleated cylinder of media according to methods known in the art to form a filter element 30 that directs fuel through the composite media 10.

The disclosed base media 16 may be manufactured by any conventional “wet laid” paper-making technology, the steps of which are well understood by those skilled in the art. According to one aspect, the disclosed base media 16 is a non-woven filtration media which is comprised of a blend of staple synthetic fibers and fibrillated cellulosic fibers. According to certain embodiments, the staple synthetic fibers will most preferably comprise or consist of synthetic microfibers. Optionally, the base media 16 may contain non-fibrillated cellulosic fibers in an amount which does not significantly adversely affect the filtration efficiency and/or capacity of the media.

Certain embodiments of the base media will be in the form of high efficiency and high capacity glass-free non-woven filtration media comprising a blend of synthetic non-fibrillated staple fibers and fibrillated cellulosic staple fibers, wherein the fibrillated cellulosic fibers are present in the media in an amount to achieve an overall filtration efficiency at 4 microns of about 95% or higher and a ratio of filtration capacity to media caliper of 0.4-0.5 mg/in²/mils and greater. The fibrillated cellulosic fibers reduce mean pore diameters to between 3 and 5 microns by bridging larger pores between larger diameter cellulose and synthetic fibers.

The synthetic non-fibrillated staple fibers may be formed of a thermoplastic polymer selected from the group consisting of polyesters, polyalkylenes, poyacrylonitriles, and polyamides. Polyesters, especially polyalkylene terephthalates, are especially desirable. Some embodiments will include non-fibrillated polyethylene terephthalate (PET) staple microfibers having an average fiber diameter of less than about 10 microns and an average length of less than about 25 millimeters and having an aspect ratio of at least 1000. A preferred base media embodiment includes 0.4 denier PET fibers having a diameter of approximately 6 μm and a length of less than 25 mm. At least some of the PET microfibers preferably have a non-round configuration that is flat or wedge shaped, in which case the PET microfibers have a major diameter of less than about 10 μm and a minor diameter of less than 5 μm. The synthetic staple fibers may be present in an amount between about 50 wt. % to about 99.5 wt. % ODW. In preferred embodiments, the PET microfibers are present in an amount greater than 80 wt. % ODW and more preferably the PET microfibers are present in an amount greater than 90 wt. % ODW. Some embodiments may employ a mixture of round and non-round synthetic microfibers. The uniformity of the synthetic microfibers enhances formation of the resulting wet laid media, permitting reduction in thickness and resulting flow restriction of the disclosed base media.

Nanofibrillated Cellulose (NFC) refers to cellulose fibers that have been fibrillated to achieve agglomerates of cellulose nanofibrils. NFCs have nanoscale (less than 100 nm) diameters and a typical length of several micrometers, resulting in aspect ratios greater than 1000. The fibrillated cellulosic staple fibers may comprise fibrillated lyocell nanofibers. Certain embodiments will include fibrillated lyocell nanofibers in an amount of between about 0.5 to about 50 wt. % ODW. The fibrillated cellulosic staple fibers may possess a Canadian Standard Freeness (CSF) of about 300 mL or less. NFC has an extremely high surface to volume ratio, with between 40 and 200 billion nanofibrils/gram. The surface of NFC may be modified to make it hydrophobic. Acetylation, Silylation, and treatment with Isocyanate can be used to make the surface of NFC hydrophobic. It is believed that a hydrophobic surface on the NFC will resist water attachment to the fibers and could promote adhesion of soft particles such as asphaltenes.

Certain embodiments of the base media 16 will include a blend of staple polyethylene terephthalate (PET) microfibers having an average fiber diameter of less than about 10 microns and an average length of less than about 25 millimeters which are present in an amount of between about 50 wt. % to about 99.5 wt. % ODW, and fibrillated lyocell staple fibers having a Canadian Standard Freeness (CSF) of about 300 mL or less which are present in an amount of at least about 0.5 to about 50 wt. % ODW. The fibrillated cellulosic fibers may have an average diameter of about 1000 nanometers or less and an average length between about 1 mm to about 8 mm. More preferably, a majority of the diameters of the fibrillated cellulosic fibers fall in the range of 50 to 500 nanometers. The nano-fibrillated cellulosic fibers are added during formation of the base media 16 such that they are evenly distributed through the depth of the media, spanning pores between the larger diameter microfibers to form a uniform pore structure having an average (mean) pore size less than about 5 μm.

Other components and/or additives may be incorporated into the base media 16. By way of example, some embodiments may include natural wood pulp blended with the synthetic non-fibrillated staple fibers and fibrillated cellulosic staple fibers. If employed, the natural wood pulp may be present in an amount of about 25 wt. % ODW or less. Wet strength additives, optical brighteners, fiber retention agents, colorants, fuel-water separation aides (e.g., silicone additives and associated catalyzers), water or oil repellants (e.g., fluorocarbons), fire or flame retardants, and the like may also be employed as may be desired. Resin binders may also be added to the filtration media to achieve desired physical properties. If employed, such binder resins may be present in an amount between about 2 to about 50 wt. % SDC, with a typical value of approximately 12% resin content. Additives may be selected to promote adhesion between soft particles and the base media fiber matrix. It may also be beneficial to modify the surface of the cellulose fibers used to form the bulk of the base media, though the effectiveness of such surface modification may be limited due to the relatively small surface area of these relatively large diameter fibers.

The base media 16 may be formed by a wet-laid slurry process. By way of example, the filtration media may be made by forming a wet laid sheet from a fibrous slurry comprised of a blend of synthetic non-fibrillated staple fibers and fibrillated cellulosic staple fibers, and drying the sheet to obtain the base media 16. The blend of synthetic non-fibrillated staple fibers may include a mixture of round and non-round synthetic fibers having diameters (or major diameters) less than 10 μm and more preferably less than about 6 μm. The filtration media may be grooved and/or pleated so as to facilitate its use in filtration devices (e.g., filter units associated with on-board fuel filtration systems). The resulting wet-laid base media 16 has a mean pore size of about 3.7 μm and a maximum pore size of about 16-20 μm, a thickness of about 0.030″ (thirty thousandths of an inch), and a Gurly stiffness of approximately 2000-3000 mg. The efficiency of the base media 16 for removing 2 μm particles is about 79% particle removal. The base media 16 has a basis weight of approximately 97 lb/3000 ft². The air permeability of the base media 16 is approximately 3 cfm/ft² at 0.5″ WG.

The disclosed base media 16 is combined with alternative depth media 14 to form a composite filter media 10. As shown in FIG. 1, the composite filter media 10 may also incorporate a scrim 12 to protect the depth media 14 and enhance the strength and processing characteristics of the composite media 10. The composite media 10 may include a protective scrim 12 covering the upstream face of the fiberglass media 14 to form a three layer composite of scrim 12, depth media 14, and base media 16 as shown in FIG. 1. A non-limiting example of a suitable protective scrim 12 is a lightweight, high melting point (>425° F.) spun bond nylon 6,6 nonwoven fabric having a basis weight of about 0.5 oz/yd². The scrim 12 will not have any material effect on the filtration efficiency of the disclosed composite media, but will improve the overall tensile strength of the composite media 10 and protect the depth media 14 during handling, pleating and manufacture of filter products from the composite media 10. The protective scrim 12 is an optional feature of the disclosed composite media 10 and may not be included in all embodiments.

The depth media is selected and arranged to provide a positive density gradient from an inlet face (adjacent the scrim 12) to an outlet face (adjacent the base media 16). The density gradient results from a reduction in average diameter of the fibers making up the depth media 14, with the largest diameter fibers present at the inlet (upstream) face and smallest diameter fibers present at the outlet (downstream) face. In some embodiments, the average fiber diameter is reduced by about 80% from the inlet face to the outlet face of the depth media 14. In other embodiments, the average fiber diameter is reduced by about 90% from the inlet face to the outlet face of the depth media 14. Reference numerals 14a and 14b represent discrete layers of different fiber diameter or different “phases” of depth media where the average fiber diameter changes more gradually to form a “phased” media.

According to aspects of the disclosure, the depth media 14 is co-pleated or laminated on an upstream face of the base media 16 as shown in FIG. 1. Lamination is a process by which the media are adhered together by heat, adhesive or the like. Co-pleating is a process where the media are fed into a pleating machine at the same time and are pleated together but are not physically attached to each other. Fluid to be filtered first encounters the upstream face of the depth media 14 (or optional protective scrim 12), passes through the downstream face of the depth media 14, enters the upstream face of the base media 16 and exits through the downstream face of the base media 16.

A non-limiting example of a suitable depth filtering component for use on the upstream side of the disclosed composite media 10 is a media composed primarily of fine diameter glass fibers with a suitable binder. Glass fibers are fibers drawn from an inorganic product of fusion that has cooled without crystallizing. The fiberglass media may be manufactured using a wet laid process with a water-based binder resin as is known in the art. The glass fibers may be substantially continuous fibers or fibers having a high aspect ratio. The glass fibers have a range of diameters from relatively coarse fibers having a diameter of approximately 3 μm to fine fibers having a diameter of about 200 nm. The glass fibers are not evenly distributed through the depth of the media 14, with relatively coarse fibers predominating at the inlet face so the fiberglass media has a positive density gradient, meaning the fiberglass media is more open (less dense) at one surface and increases in density toward the opposite surface. Pore size has a direct relationship to the diameters of the fibers in a nonwoven mat, so the pore size in the fiberglass media decreases along with the diameter of the glass fibers through the depth of the media 14.

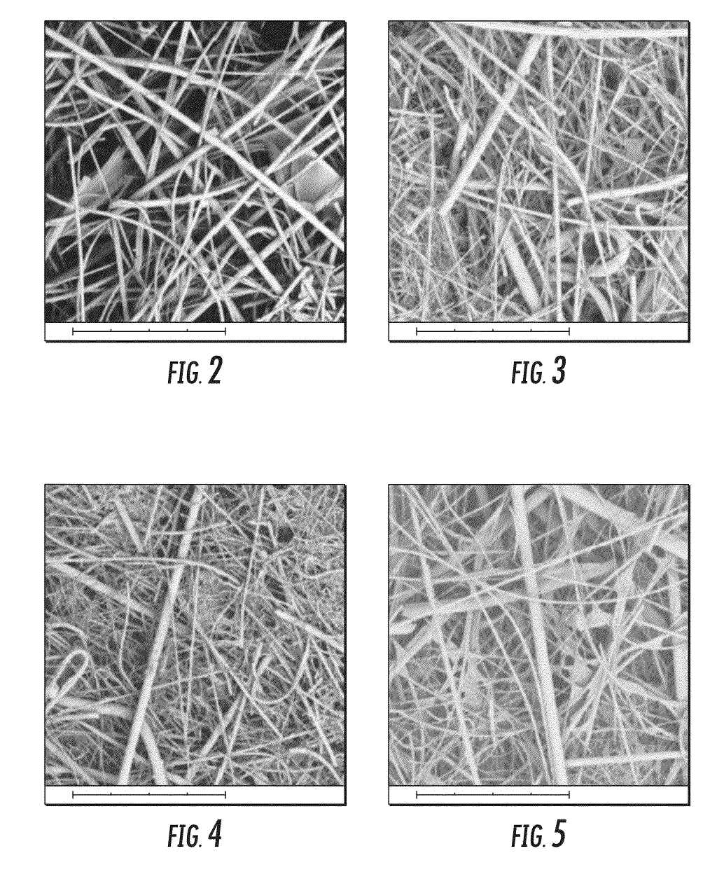

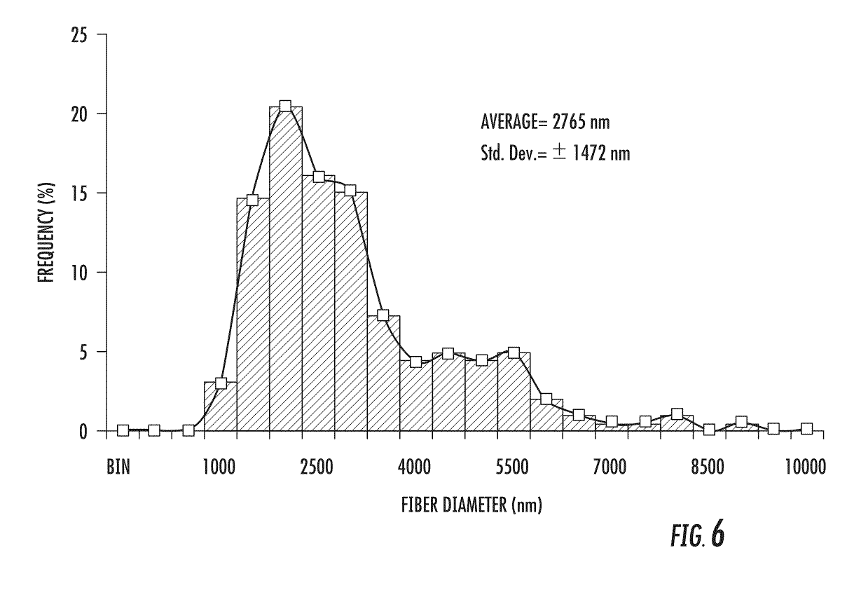

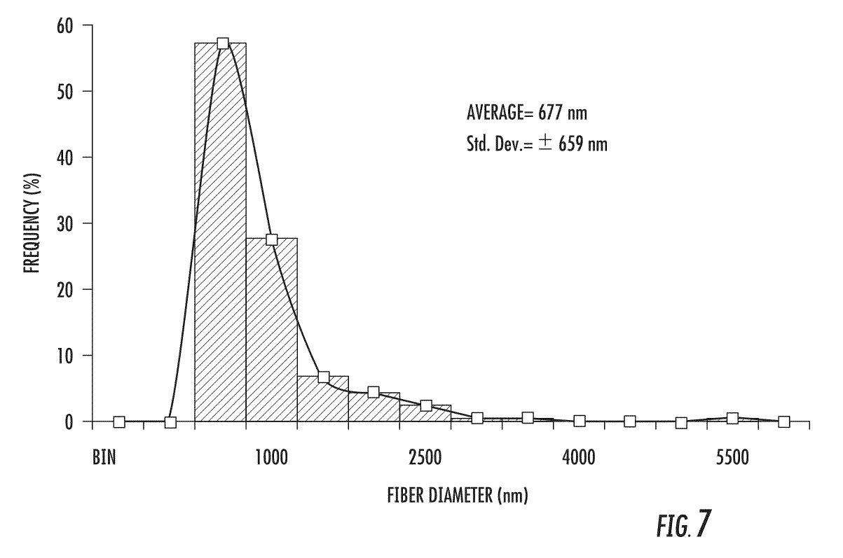

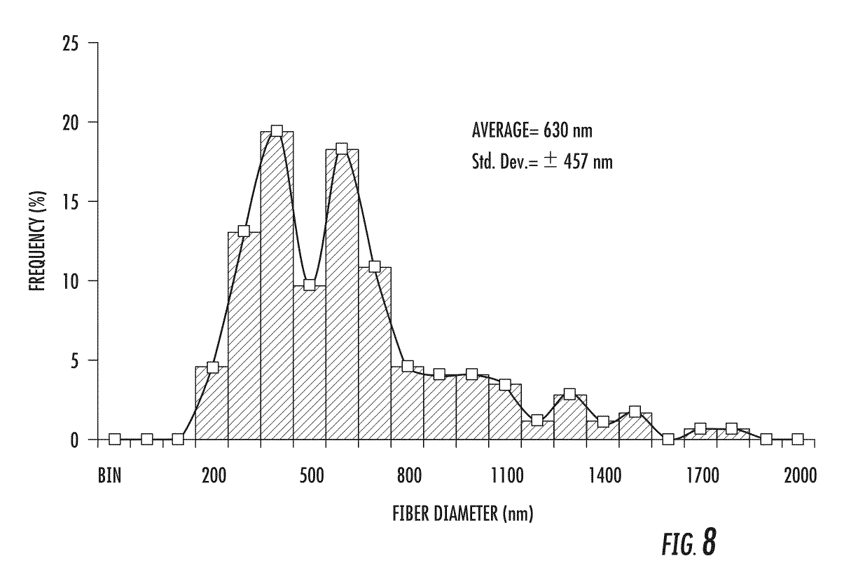

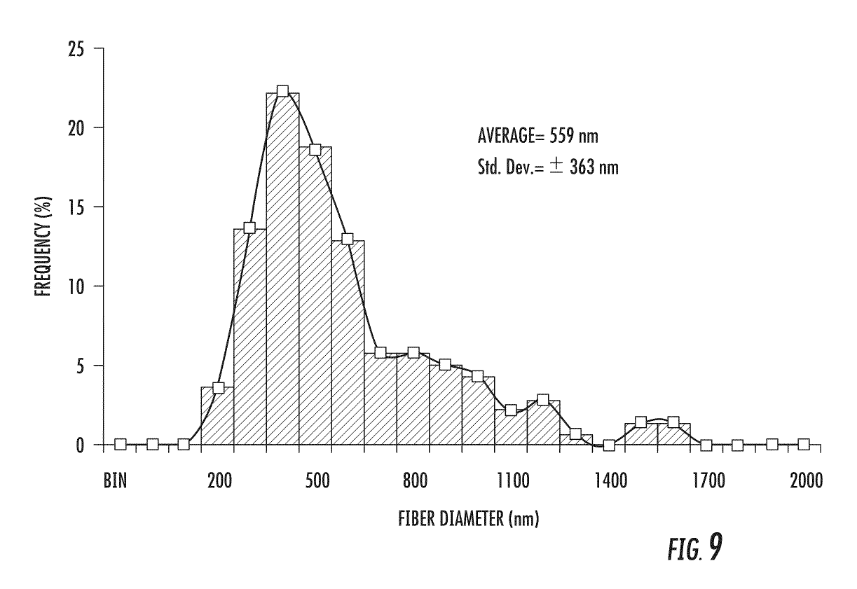

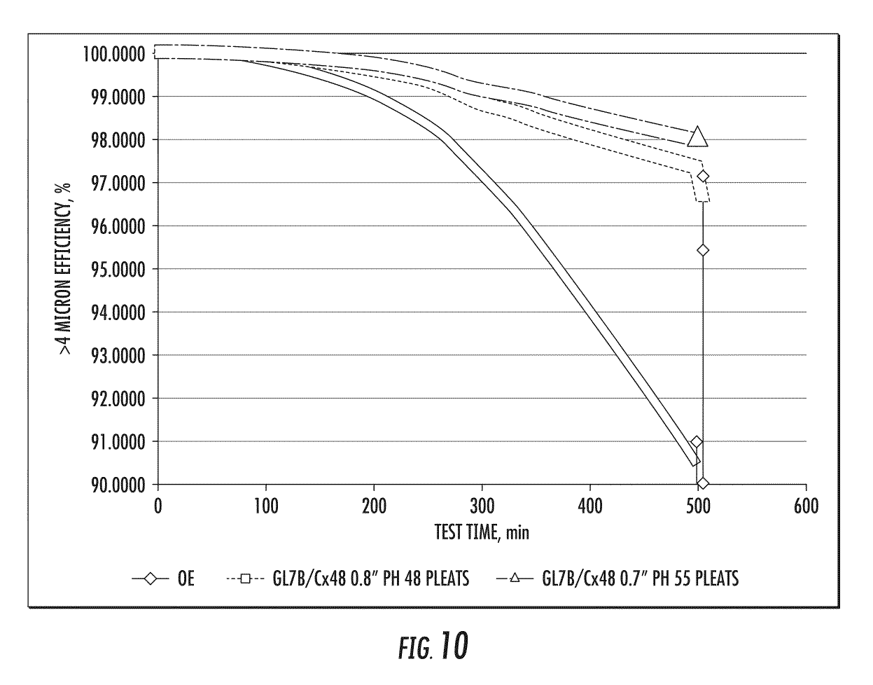

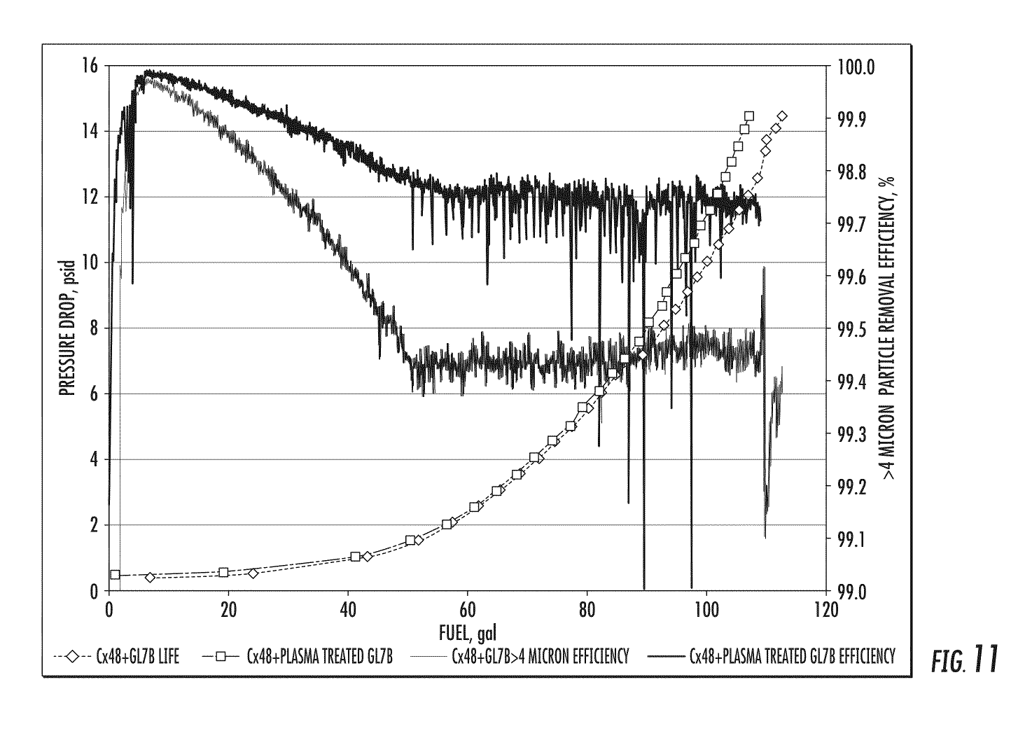

The disclosed fiberglass media can be described as a phased fiberglass media having two phases, a relatively open first phase 14a with relatively large pores and a relatively more dense and less open second phase 14b with relatively small pores. The density and pore size in the fiberglass media are directly related to the diameter of the constituent glass fibers, with larger diameter fibers between 1 μm and 3 μm predominating in the first phase 14a and finer diameter fibers in the range of 1 μm to 200 nm predominating in the second phase 14b. FIGS. 2-5 are scanning electron microscopic images of the disclosed fiberglass depth media, separated into the first and second phases, each having an upstream face and a downstream face. FIGS. 6-9 graphically present fiber diameter distribution information derived from the images of FIGS. 2-5. Average fiber diameters decrease dramatically in the depth of the fiberglass media, falling approximately 80% from an average diameter of about 2.8 μm at the upstream face of the first phase, to 677 nm at the downstream face of the first phase, to 630 nm at the upstream face of the second phase and 559 nm at the downstream face of the second phase. It is important to note that the standard deviation also decreases from the upstream face to the downstream face of the fiberglass media, indicating that the variation in fiber diameter also decreases from the upstream face to the downstream face of the fiberglass depth media.

The disclosed fiberglass depth media has a basis weight in the range of 46-54 lb/3000 ft², with a typical basis weight of 50 lb/3000 ft² as measured according to TAPPI T410. The disclosed fiberglass media has a caliper in the range of 0.012-0.026 inches, with a typical caliper of 0.018 inches as measured according to TAPPI T411 at 7.3 psi. The Frazier permeability of the fiberglass media is in the range of 9-15 ft³/min/ft², with a typical value of 13 ft³/min/ft², as measured according to TAPPI T251. The maximum pore size of the fiberglass media is in the range of 0.015-0.020 inches, with a typical maximum pore size of approximately 0.017 inches, measured according to ASTM-316-80. The fiberglass layer has a machine direction (MD) tensile strength of between 7 and 12 psi, with a target MD tensile strength of 10 psi (off machine).

An alternative embodiment of the fiberglass media may employ two or more discrete layers 14a, 14b of fine glass fiber media to provide progressively finer filtration through the depth of the fiberglass media. The fine fiberglass layers would have fiber diameters, porosity and flow characteristics selected to provide depth filtration similar to that provided by the phased fiberglass media discussed above.

The overall basis weight of the composite media 10 formed from the base media 16 and fiberglass media is about 147 LBS/3000 ft³. The caliper of the base media 16 is about 0.032″ and the caliper of the fiberglass media is about 0.018″ with the overall caliper for the composite media 10 around 0.050″. The ratio of filtration capacity to media caliper for this embodiment of the composite media 10 is approximately 1.5-2 mg/in²/mil.

Some embodiments of the fiberglass/base media composite will be treated to enhance hydrophobicity of the composite media 10 and improve water separation from fuel passing through the media. Hydrophobic treatments may be applied to the fiberglass layer prior to lamination or co-pleating, or the composite media 10 may be assembled and then treated. Several hydrophobic treatments are compatible with the disclosed composite media 10. One possible hydrophobic treatment involves exposing the media to a solution of inorganic fluid under supercritical conditions (such as super critical CO₂ “SCCO₂”) with a dissolved fluorinated urethane polymer, where the fluorinated urethane polymer precipitates out of solution to coat the fibers of the media as disclosed in U.S. Pat. Nos. 7,771,818 and 8,735,306. An alternative hydrophobic treatment is a fluorinated plasma treatment such as that described in U.S. Pat. No. 6,419,871. A further alternative hydrophobic treatment is a continuous “wet” process such as described in U.S. Pat. No. 6,676,993 in which water based dispersions containing fluoropolymers are drawn into the pores of a filter media to coat fibers and nodes within the media with fluoropolymer. In each case, the treatment results in a fluoropolymer surface residue or coating on the fibers of the fiberglass layer or the composite media 10 that is “hydrophobic” and repels water.

The resulting hydrophobicity of the fiberglass/base media composite can be measured in terms of the “water contact angle” and the efficiency that the composite filter media separates water from fuel passing through the composite filter media 10. The contact angle is defined as the angle between a liquid drop and a surface of a solid taken at the tangent edge where the liquid drop contacts the solid surface. The contact angle is 180° when a liquid forms a spherical drop on the solid surface, indicating a perfectly hydrophobic surface with no wetting. The contact angle is 0° when the drop spreads to a thin film over the solid surface, indicating a hydrophilic surface. The degree to which a liquid my “wet” a solid depends upon the contact angle. At a contact angle of 0°, the liquid wets the solid so completely that a thin liquid film is formed on the solid. When the contact angle is greater than 90° the liquid does not wet the solid. If the contact angle is less than 90°, the liquid can be drawn into capillaries formed between fibers of the media, whereas if the contact angle is greater than 90°, there will be a force to drive the liquid out of the capillaries. The capillary force relates to the surface tension of the liquid relative to the surface energy of the solid. Water has a relatively high surface tension value because the attraction between water molecules is relatively high due to hydrogen bonding. Fluorinated polymers or fluoropolymers have a relatively low surface energy because of the strong electronegativity of the fluorine atom.

The untreated fiberglass layer has relatively high surface energy and is readily wetted, or hydrophilic, with no detectable water contact angle. After exposure to one of the above-described hydrophobic treatments, the fiberglass layer or composite media has a contact angle of between 120° and 150°, indicating a hydrophobic surface. The above-described hydrophobic treatments leave a coating or residue that slightly reduces the porosity and average pore size of the fiberglass layer.

| | | | Mean Flow | |
|---|---|---|---|---|
| | Bubble Point, | | Pore Size, | |
| Sample | micron | s.d. | micron | s.d. |
| Fiberglass | 15.87 | 0.44 | 3.89 | 0.24 |
| media | | | | |
| untreated | | | | |
| Fiberglass | 15.77 | 0.09 | 3.68 | 0.26 |
| media | | | | |
| plasma | | | | |
| treated | | | | |
| Fiberglass | 15.55 | 0.36 | 3.47 | 0.14 |
| media | | | | |
| “wet” | | | | |
| treated | | | | |

The air permeability is slightly reduced in the treated fiberglass media from approximately 13 f³/m to between 9 f³/m and 13 f³/m after treatment. Hydrophobic treatment of the fiberglass layer and/or the composite media enhances water separation by the composite media from approximately zero to at least 95% as shown in the test results below.

| Test Fuel | Diesel | Clay Treatment? | YES |
|---|---|---|---|
| | Fuel #2 | | |
| Flow-rate | 4 | [Gallons/Hour] | |
| Interfacial | 24.3 +/− 1.0 | [Dynes/cm] | |
| Tension | | | |
| Initial H2O | 90.1 +/− 9.5 | [PPM] | |
| Content | | | |
| MSEP | 89.9 +/− 1.5 | Specific Gravity | 0.842 |

| Sample form | Flat sheet | | | |
|---|---|---|---|---|
| Sample | Composite | Composite | Composite | Composite |
| configuration | media | media | media after | media after |
| | | after “wet” | “supercritical | fluorinated |
| | | treatment | CO2” | plasma |
| | | | treatment | treatment |
| average of two | ~0 | 95.25 | 96.2 | 96.05 |
| water removal | | | | |
| efficiency (%) | | | | |

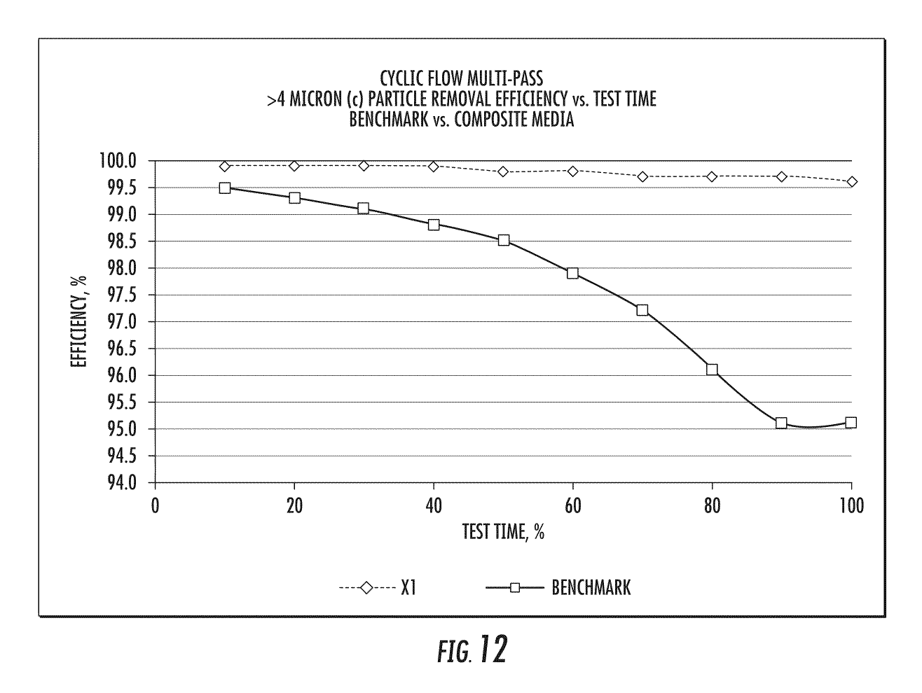

FIG. 10 is a graphical presentation of test data comparing a benchmark filter media with the fiberglass/base media composite in the same housing and under the same test conditions. The media is arranged in the housing in a pleated cylinder so fuel flows through the media from an area surrounding the media to a central region. One test was performed with the fiberglass/base media composite formed into a closed cylinder with 48 pleats, each having a pleat height of 0.8″ and another test was performed with the fiberglass/base media composite formed into a closed cylinder with 55 pleats, each having a pleat height of 0.7″. Both tests showed efficiency in removal of 4 μm particles significantly better than the OE benchmark and greater than 96% up to terminal pressure drop across the filter assembly.

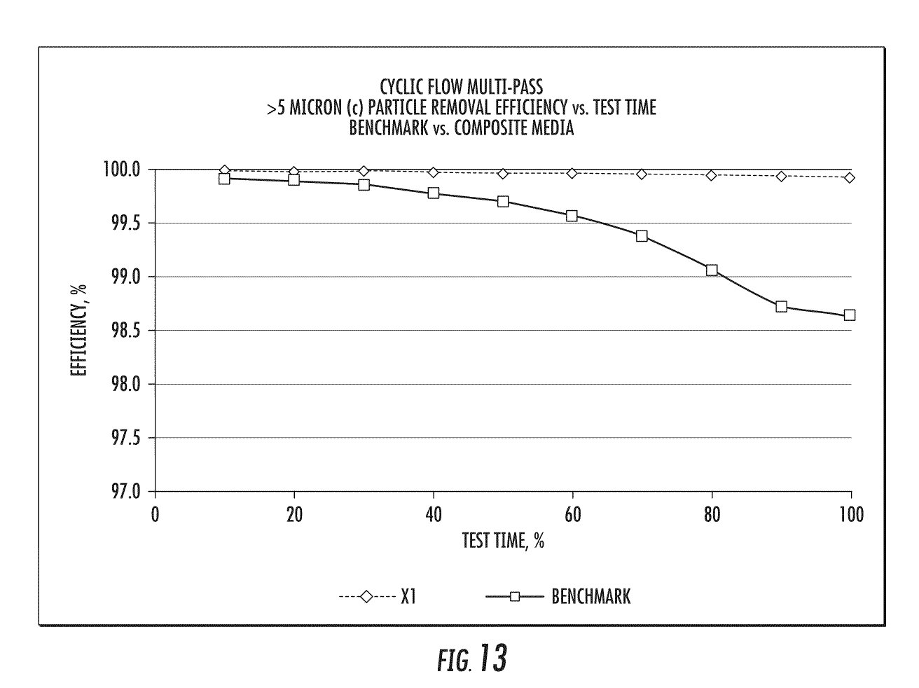

FIG. 11 graphically illustrates test results comparing the filter life and 4 μm particle removal efficiency of an untreated fiberglass/base media composite to a composite constructed with a fiberglass layer treated with fluorinated plasma to enhance hydrophobicity. FIG. 11 shows that the composite media with hydrophobic fiberglass media is more efficient at particle removal and has a slightly shorter filter life, which is consistent with the reduced pore size from the fluorinated plasma treatment.

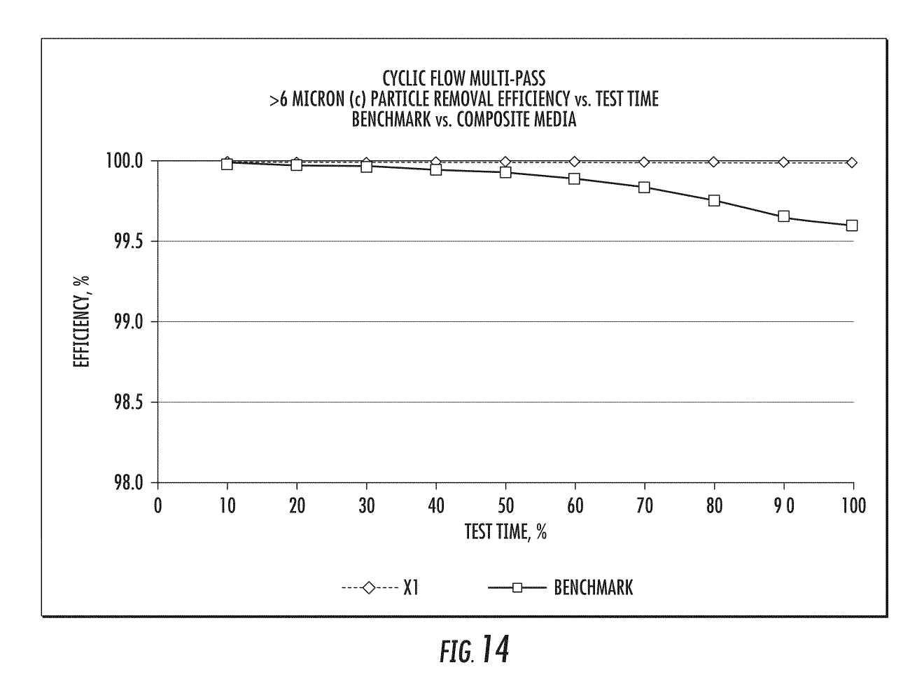

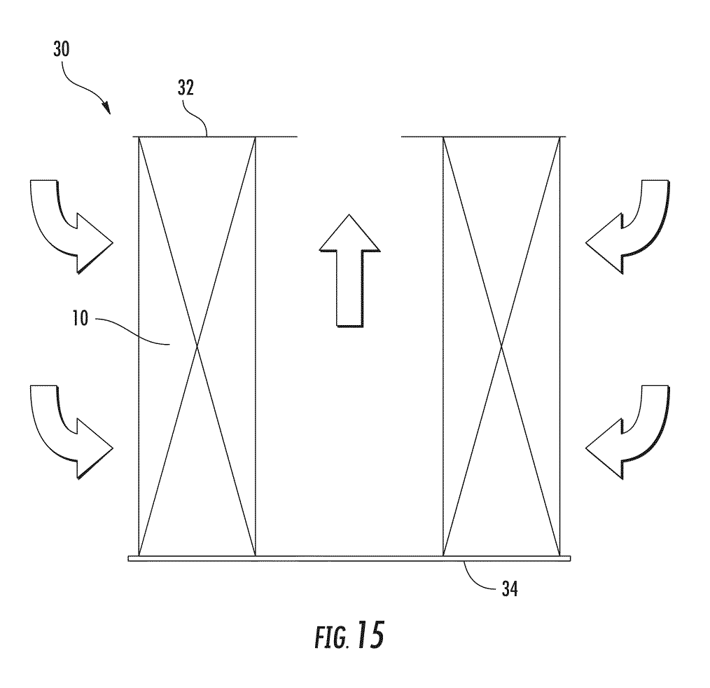

FIGS. 12-14 compare the particle removal efficiency of the fiberglass/base media composite to a benchmark in a multi-pass test performed under cyclic flow conditions. The flow cycled from 377 to 188 liters per hour once every 10 seconds for the duration of the test. The filters were tested with ISO fine test dust. The benchmark and fiberglass/base media composite were arranged in the same filter housing and tested at the same test parameters. Under cyclic flow conditions, the fiberglass/base media composite maintains high efficiency until terminal pressure drop (10 psid across filter assembly) is reached, while the benchmark's efficiency deteriorates. There is no particle size at which the efficiency of the fiberglass/base media composite was below 99%. The tests were performed in accordance with ISO 19438 and establish that the retained dust capacity of the fiberglass/base media composite is 23.69 g, compared to 16.34 g for the benchmark, or a 45% increase in retained dust capacity to terminal pressure drop in the same filter envelope. Even though the initial differential pressure across the filter assembly with the fiberglass/base media composite was approximately 5% higher than the benchmark (5.2 psid v. 5 psid), the fiberglass/base media composite had a substantially longer filter life to terminal pressure drop under cyclic flow test conditions.

A non-limiting alternative example of a suitable depth media 14 will now be described. Other materials, fiber sizes, thicknesses and combinations may also be effective. One or more layers of fine synthetic and/or polymer fibers may be added to the base media 16 to trap large diameter particles and prevent the formation of a “cake” on an upstream face of the base media 16. The layers of polymer fibers add a depth filtration component to the composite media 10, allowing the composite media 10 to trap and hold far more material than is possible with only the base media 16. The largest particles are retained in the polymer fiber layers, thereby “protecting” the base media 16 and its fine pores from the bulk of material being removed from the fluid. When the fluid reaches the base media 16, only the fine particles remain to be removed and the pore structure of the base media remains open, so the pressure drop through the composite media is minimized to prolong media effective life.

One exemplary embodiment of a synthetic depth media is a layered or phased non-woven media composed of meltblown thermoplastic fibers. An example of a suitable thermoplastic is polybutylene terephthalate (PBT), but other thermoplastic or polymer fibers may be compatible with the disclosed composite media. The synthetic depth media is selected and arranged to provide a positive density gradient from an inlet face (adjacent the optional scrim 12) to an outlet face (adjacent the base media 16). The synthetic depth media is co-pleated or bonded to the base media 16 to form a composite media 10. Alternative bonding methods are known and may be compatible with the disclosed embodiments. The resulting composite filter media can then be grooved, pleated and used in filter elements for filtering diesel fuel, for example.

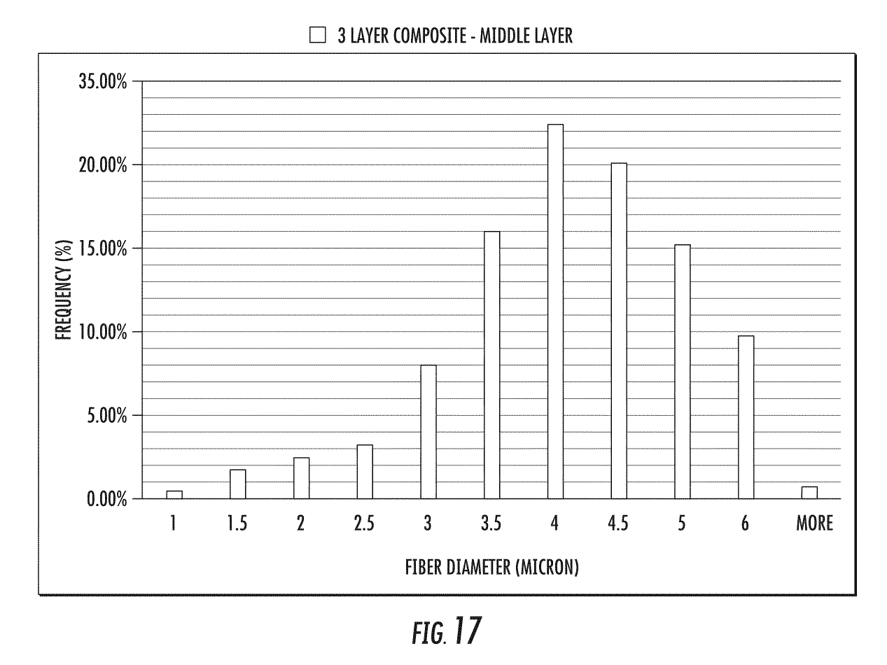

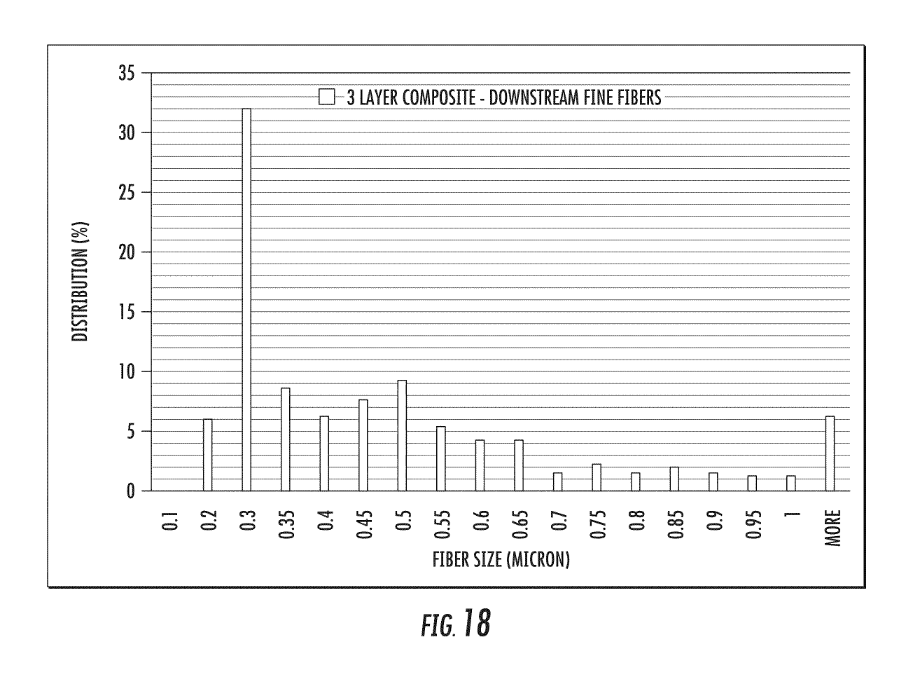

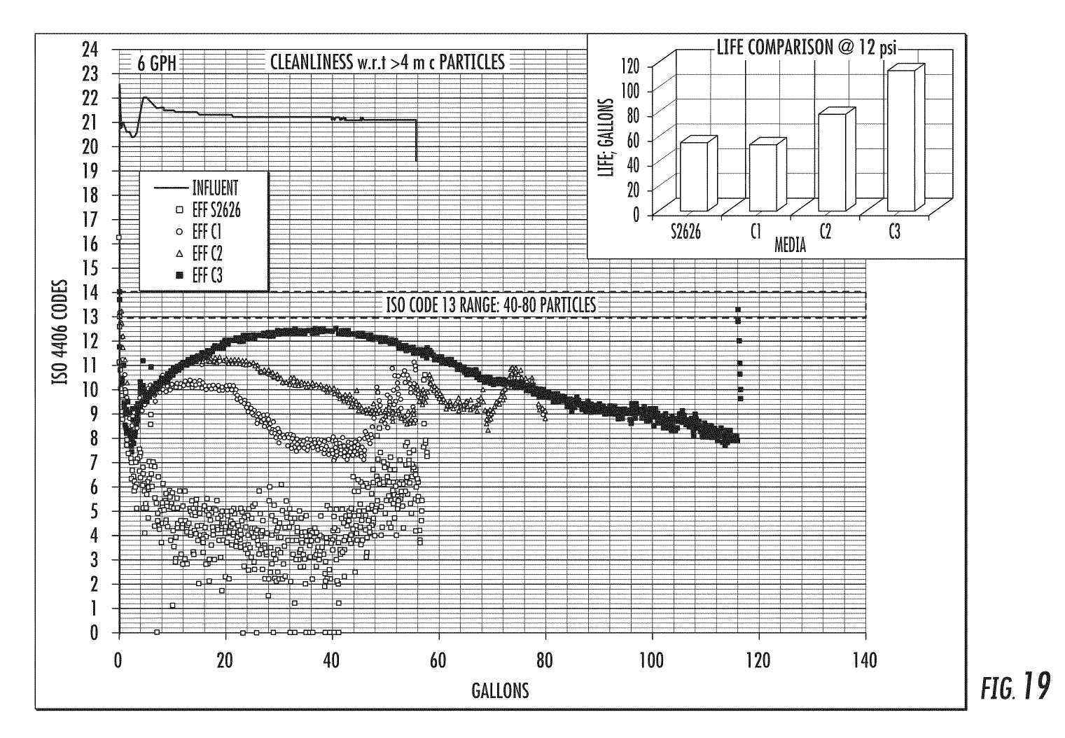

With reference to FIGS. 16-18, the disclosed meltblown nonwoven has three phases or layers of fibers, with the coarsest (large diameter) fibers adjacent the inlet face and the finest (small diameter) fibers adjacent the outlet face. As the fiber diameter decreases, the density of the meltblown nonwoven increases. The first upstream layer of fibers (not counting the scrim layer) has a mean fiber diameter of about 7 microns and a basis weight of about 29 g/m². See FIG. 16. The second layer of fibers, downstream from the first layer, has a mean fiber diameter of about 2 microns and a basis weight of about 40 g/m². See FIG. 17. The third layer of fibers, downstream from the second layer and adjacent the base media, are very fine meltblown polyester fibers having a mean diameter of less than one micron, with a majority of the fibers being between about 0.2 micron and 0.7 micron and a basis weight of about 24 g/m². See FIG. 18. The fiber layers progress from large to small in terms of both the fiber diameters and the porosity of the layers, with the finest pores being in the base media. Fiber diameters decrease through the depth of the meltblown media by at least 80% and preferably about 90%.

In flat sheet testing, the base media 16 has a pressure drop of about 0.91 PSID, while a composite media 10 formed from a three layer meltblown and the base media 16 had an increased pressure drop of 1.15 PSID. The composite filter media 10 was effective at preventing a cake from forming on the surface of the base media and preserving acceptable pressure drop across the media, resulting in a useful life for the composite media approximately double that of the base media alone. The meltblown/base media composite had a beta of about 500 (99.8%) for 4 micron particles. The total loft of the metlblown/base media composite media was about 41 thousandths of an inch (0.041″). The meltblown/base media composite has an efficiency of at least (ISO 4406) 13 for 4 micron particles when tested at 12 psi pressure differential. See FIG. 19.

The above specification, examples, and data provide a complete description of the manufacture and use of the invention. Many embodiments of the invention can be made.

What is claimed is:

1. A filtration medium comprising:
a non-woven web base medium predominantly formed of synthetic microfibers having a diameter less than 10 μm and including fibrillated cellulosic fibers in an amount not exceeding 25 wt. % ODW, said base medium having a 2 μm particle removal efficiency of at least 70%; and
a non-woven web depth medium arranged on an upstream face of said base medium, said depth medium having an inlet face directed away from said base medium and an outlet face adjacent said base medium, said depth medium having a positive density gradient from said inlet face to said outlet face, said depth medium comprised of fibers having an average diameter that is at least 80% smaller at said outlet face of said depth medium than an average fiber diameter at said inlet face,
wherein said filtration medium has a beta of approximately 500 for removal of 4 μm particles.

2. The filtration medium of claim 1, wherein said base medium has a 4 μm particle removal efficiency of at least 95% and a ratio of filtration capacity to media caliper of 0.4-0.5 mg/in²/mils and greater.

3. The filtration medium of claim 1, wherein said depth medium comprises fiberglass microfibers having average diameters of approximately 2.8 μm at said inlet face and average diameters of approximately 560 nm at said outlet face.

4. The filtration medium of claim 1, wherein said synthetic microfibers include fibers having non-round cross sectional shapes.

5. The filtration medium of claim 1, wherein said depth medium comprises polymer microfibers having a mean fiber diameter of approximately 7 μm at said inlet face and mean a fiber diameter of less than 1 μm at said outlet face.

6. The filtration medium of claim 1, wherein said base medium has mean pore diameter of between 3 μm and 5 μm.

7. The filtration medium of claim 1, wherein said fibrillated cellulosic fibers comprise fribrillated lyocell fibers having diameters predominantly in the range of 50 nm to 500 nm.

8. The filtration medium of claim 1, wherein said synthetic microfibers and said fibrillated cellulosic fibers each have an aspect ratio of at least 1000.

9. The filtration medium of claim 1, wherein said depth medium is comprised of fiberglass microfibers and has a Frazier permeability in the range of 9-15 ft³/m in/ft².

10. A method of filtering fluid-borne particles, comprising:
flowing a fluid containing fluid-borne particles through a filtration medium comprising a non-woven web depth medium and a non-woven web base medium, said depth medium having an inlet face facing said fluid flow and an outlet face opposite said inlet face, said depth medium having a positive density gradient from said inlet face to said outlet face, said depth medium comprised of fibers having an average diameter that is at least 80% smaller at said outlet face of said depth medium than an average fiber diameter at said inlet face; and
a non-woven web base medium adjacent the outlet face of said depth medium, said base medium predominantly formed of synthetic microfibers having a diameter less than 10 μm and including fibrillated cellulosic fibers in an amount not exceeding 25 wt. % ODW, said base medium having a 2 μm particle removal efficiency of at least 70%;
wherein said filtration medium has a beta of approximately 500 for removal of 4 μm fluid borne particles, which are entrapped within said filtration medium.

11. The method of filtering fluid-borne particles of claim 10, wherein said base medium has a 4 μm particle removal efficiency of at least 95% and a ratio of filtration capacity to media caliper of 0.4-0.5 mg/in²/mils and greater.

12. The method of filtering fluid-borne particles of claim 10, wherein said depth medium comprises polymer microfibers having a mean fiber diameter of approximately 7 μm at said inlet face and mean a fiber diameter of less than 1 μm at said outlet face.

13. The method of filtering fluid-borne particles of claim 10, wherein said synthetic microfibers include fibers having non-round cross sectional shapes.

14. The method of filtering fluid-borne particles of claim 10, wherein said synthetic microfibers and said fibrillated cellulosic fibers each have an aspect ratio of at least 1000.

15. The method of filtering fluid-borne particles of claim 10, wherein said filtration medium has a filtration capacity to media caliper of approximately 1.5-2 mg/in²/mil.

16. The method of filtering fluid-borne particles of claim 10, wherein said fibrillated cellulosic fibers comprise fribrillated lyocell fibers having diameters predominantly in the range of 50 nm to 500 nm.

17. The method of filtering fluid-borne particles of claim 10herein said depth medium comprises fiberglass microfibers having average diameters of approximately 2.8 μm at said inlet face and average diameters of approximately 560 nm at said outlet face.
